(19) United States
(12) Patent Application Publication
(10) Pub. No.: US 2022/0164262 A1
(43) Pub. Date: May 26, 2022

(54) CRITICAL DATA STORAGE

(71) Applicant: Hewlett-Packard Development Company, L.P., Spring, TX (US)

(72) Inventors: David Jos Vainikka, Vancouver, WA (US); Michael Walters, Vancouver, WA (US)

(73) Assignee: Hewlett-Packard Development Company, L.P., Spring, TX (US)

(21) Appl. No.: 17/426,327

(22) PCT Filed: Apr. 24, 2019
(86) PCT No.: PCT/US2019/028825

§ 371 Date: Jul. 28, 2021

(51) Int. Cl. G06F 11/14; G06F 3/06; G06F 8/65

(52) U.S. Cl. CPC G06F 11/1469; G06F 3/0619; G06F 8/65; G06F 3/0673; G06F 3/065

(57) ABSTRACT

An example system for critical data storage can include a first controller comprising a processor and a non-transitory machine-readable medium (MRM) communicatively coupled to the processor. The non-transitory MRM can include instructions executable by the processor to cause the processor to receive a request for a new critical data type, store the new critical data type in a reserve within the nontransitory MRM, and restore the new critical data type from the reserve to a second controller responsive to replacement of the first controller with the second controller and a subsequent firmware update.

### BACKGROUND

Data storage is the recording (e.g., storing) of data (also known as information) in a storage medium. Creating a backup, also known as a data backup, includes the copying of data into an archive file of a computing device that is in secondary storage, so that it may be used to restore an original after a data loss event.

### BRIEF DESCRIPTION OF THE DRAWINGS

FIG. 1 is an example system for critical data storage consistent with the present disclosure.

FIG. 2 is another example system for critical data storage consistent with the present disclosure.

FIG. 3 is an example method for critical data storage consistent with the present disclosure.

FIG. 4 is another example method for critical data storage consistent with the present disclosure.

### DETAILED DESCRIPTION

Critical data includes data that a computing device uses to function in a desired manner. If the critical data is lost, the computing device does not function in the desired manner. For instance, a printing device at an office supply store that is used by customers may include a usage count (e.g., colored copy count, black and with copy count, etc.) as critical data. If the printing device does not include the usage count data, the printing device does not perform as desired. Without the usage count, customer copies using the printing device may not be tracked for payment.

As used herein, a computing device can be a mechanical or electrical device that transmits or modifies energy to perform or assist in the performance of human tasks. Examples include personal computers, laptops, tablets, smartphones, mobile devices, and gaming consoles, among others. Example computing devices may also include printing devices. As used herein, a printing device includes a hardware device that transfers a print substance on to a print media such as paper. Examples include laser printers, light-emitting diode (LED) printers, ink jet printers, solid ink printers, thermal printers, and three-dimensional (3D) printers, among others.

A computing device includes a controller such as an application specific integrated circuit (ASIC), a field programmable gate array (FPGA), a metal-programmable cell array (MPCA), or other combination of circuitry and/or logic configured to orchestrate execution of machine-readable instructions. The computing device also includes firmware, that when updated, affects the controller and the data recognized by the controller. When the controller is replaced by a new controller (e.g., responsive to failure of the controller), the new controller may be unaware of any data that has been added after manufacture of the new controller.

For instance, if a printing device is provided to an office supply store and a subsequent request is made to add a usage count as critical data to the printing device, the usage count can be added and recognized by the printing device's controller as critical data. However, if the controller is later replaced with a new controller, the new controller may not be aware of the usage count or its status as critical data. The critical data may be lost, and the printing device may not perform as desired.

Some approaches to critical data storage include the use of a critical data backup (COB), which stores critical data. For instance, as used herein, a COB is a memory device, such as a non-transitory machine-readable medium (MRM), whose contents result from copying or archiving critical data files and folders for the purpose of being able to restore them in case of critical data loss. However, a CDB is static and cannot adjust or adapt to a replacement controller. When communication to the original controller is lost, the critical data in the CDB may not be restored to the new controller.

Other approaches include updating firmware on the computing device and subsequently replacing the controller. This can be time-consuming and costly, as a plurality of firmware updates may be attempted before a version that matches the critical data is found. This may result in high labor costs, for instance, as a service technician may need to take time to try multiple firmware updates and perform multiple restarts before critical data is recovered, Other approaches include sending the computing device and/or the new controller to a manufacturer for recalibration. Such an approach may also be time-consuming and costly.

In contrast, examples of the present disclosure allow for storage of critical data on a reserve in a non-transitory MRM such as a COB that preserves and updates the critical data even when a controller is replaced. For instance, some examples of the present disclosure include a COB housing a reserve, also known as an “orphanage”. The reserve can store, preserve, and update critical data that would otherwise be lost when a controller is replaced. Subsequent to replacement of the controller, firmware is updated, and the critical data is restored. Some examples of the present disclosure can be less time-consuming and less costly than other approaches because once the controller is replaced and the firmware updated, the critical data can be restored without multiple attempts or recalibration.

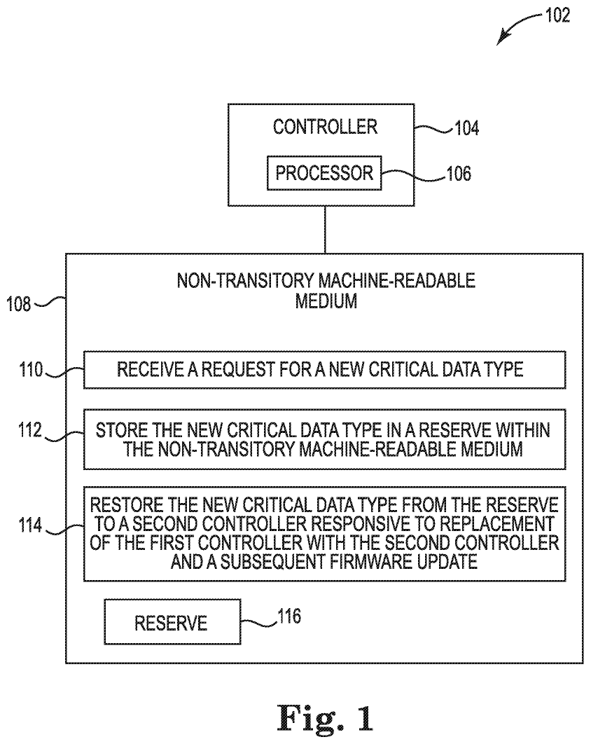

FIG. 1 is an example system 102 for critical data storage consistent with the present disclosure, System 102 can be a computing device or part of a computing device in some examples. System 102 can include a controller 104 and a processor 106 communicatively coupled to a non-transitory MRM 108 on which may be stored instructions, such as instructions 110, 112, and 114. As used herein, “communicatively coupled” can include coupled via various wired and/or wireless connections between devices such that data can be transferred in various directions between the devices. Although the following descriptions refer to a processor and a memory resource, the descriptions may also apply to a system with multiple processors and multiple memory resources, In such examples, the instructions may be distributed (e.g., stored) across multiple non-transitory MRMs and the instructions may be distributed (e.g., executed by) across multiple processors.

The non-transitory MRM 108 may be electronic, magnetic, optical, or other physical storage device that stores executable instructions. Thus, the non-transitory MRM 108 may be, for example, Random Access Memory (RAM), an Electrically-Erasable Programmable ROM (EEPROM), a storage drive, an optical disc, a COB, and the like. The non-transitory MRM 108 may be disposed within a device, such as a computing device. In this example, the executable instructions 110, 112, and 114 can be “installed” on the device. Additionally and/or alternatively, the non-transitory MRM 108 can be a portable, external or remote storage medium, for example, that allows the system 102 to download the instructions 110, 112, and 114 from the portable/external/remote storage medium. In this situation, the executable instructions may be part of an “installation package”. As described herein, the non-transitory MRM 108 can be encoded with executable instructions for performing various functions described herein.

The non-transitory MRM 108 can have available storage space thereon not used for static backup. This available storage space can be used as a reserve 116, also referred to as an orphanage, The reserve 116 is “shimmed” into free space of the non-transitory MRM 108. The reserve 116 is located on the non-transitory MRM 108, and in some examples is a table. The reserve 116 can store data newly classified as critical data, and the reserve can shelter and preserve the newly classified critical data, as it is not housed on the controller 104 and not processed by the processor 106. The reserve 116 may be referred to as an orphanage because it can house orphan data (also known as “orphans”) until a firmware update that matches orphans allowing for their restoration. Orphan data in the reserve 116 can include data store identifiers (DSIDs) that allow for removal of older data or replacement of older data with newer data if the reserve 116 reaches capacity.

The controller 104 can be a combination of hardware and/or instructions for critical data storage. The hardware, for example, can include the processor 106 and/or the non-transitory MRM 108 communicatively coupled to the processor 106. In some examples, the controller 104 can be an ASIC, FPGA, MPCA, or other combination of circuitry and/or logic configured to orchestrate execution of instructions 110, 112, and 114.

The processor 106 may include processing circuitry such as a hardware processing unit such as a microprocessor, microcontroller, application specific instruction set processor, coprocessor, network processor, or similar hardware circuitry that may cause machine-readable instructions to be executed. In some examples, the processor 106 may be a plurality of hardware processing units that may cause machine-readable instructions to be executed. The processor 106 may include central processing units (CPUs) among other types of processing units.

Instructions 110, when executed by a processor such as the processor 106, can include instructions to receive a request for a new critical data type. For instance, a request may be made for a critical data type that is not currently recognized by the controller 104 or associated firmware. In some examples, the new critical data type includes a usage count setting, a calibration setting, and/or a customization setting. For instance, a user may determine after delivery of a computing device that a new critical data type is to be added to the computing device. For example, a user may determine a particular calibration setting is critical data such that the computing device does not perform as desired without the calibration setting. Because the request was received subsequent to manufacture of the controller 104 and original firmware installation, the controller 104 may be unaware of the newly requested critical data type. The new critical data type can be added to the firmware associated with the controller 104, facilitating awareness of the new critical data type by the controller 104.

Instructions 112, when executed by a processor such as the processor 106, can include instructions to store the new critical data type in the reserve 116 within the non-transitory MRM 108 (e.g., a CDB memory device). The reserve 116 can preserve and/or update the new critical data type is updated while it is stored in the reserve 116. For instance, the aforementioned calibration setting can be preserved and updated while in the reserve such that any changes are not lost when the calibration setting is eventually restored to a second controller (e.g., a replacement controller).

Instructions 114, when executed by a processor such as the processor 106, can include instructions to restore the new critical data type from the reserve 116 to a second controller responsive to replacement of the first controller (e.g., the controller 104) with the second controller and a subsequent firmware update. When the first controller, which is aware of the new critical data type, is replaced by the second controller, the second controller does not retain the awareness of the new critical data type. For instance, the second controller may not include a firmware update the first controller underwent. As a result, the second controller is unaware of the new critical data type.

In some examples, upon replacement of the first controller with the second controller (e.g., due to a failure of the first controller), firmware associated with the second controller is updated. The update can be automatic, such that little or no human intervention occurs, or it can be user-initiated (e.g., the user responds to a prompt following replacement). This firmware update results in a search of the reserve 116 for orphan data. The reserve 116 can be a table or data store, and the orphan data can be identified using DSIDs. The orphan data includes data that does not exist in a current firmware version. When firmware is updated, the orphan data may lose its orphan status responsive to a match of the orphan during the firmware update. For instance, in some examples of the present disclosure, during the firmware update that occurs subsequent to the replacement of the first controller with the second controller, the new critical data type stored in the reserve 116 loses its orphan status, as it is matched during the firmware update. As a result, the new critical data type (and associated results, if applicable) are restored to the second controller. The associated device can function as desired with the second controller just as it functioned with the first controller.

In some examples, the firmware update can be an upgrade or a downgrade. For instance, the firmware update can be a firmware downgrade responsive to the second controller having firmware associated therewith that is older than firmware associated with the first controller. Alternatively, the firmware update can be a firmware upgrade responsive to the second controller having firmware associated therewith that is newer than firmware associated with the first controller.

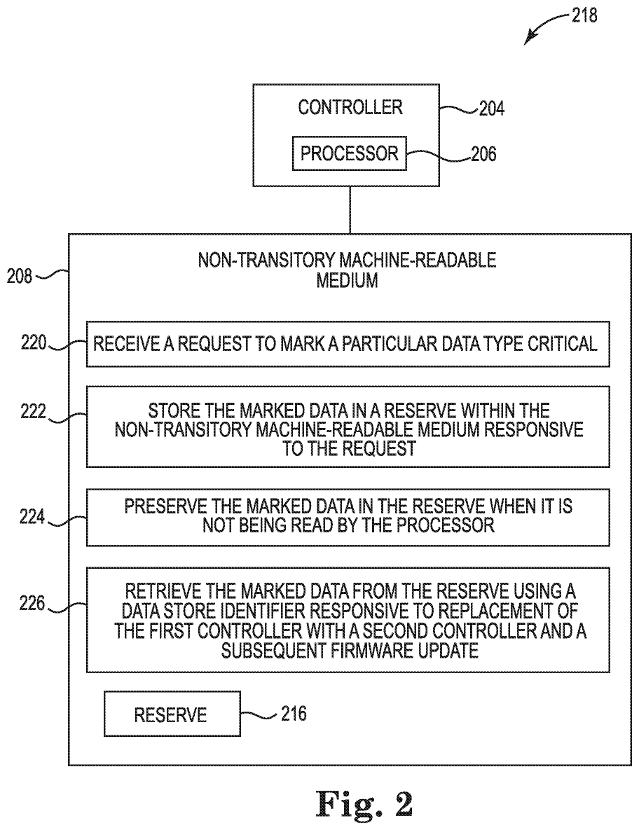

FIG. 2 is another example system 218 for critical data storage consistent with the present disclosure. In some examples, the system 218 and its components may be analogous to system 102 and its components as illustrated in FIG. 1. System 218 can be a computing device or part of a computing device in some examples. System 218 can include a controller 204 and a processor 206 communicatively coupled to a non-transitory MRM 208 on which may be stored instructions, such as instructions 220, 222, 224, and 226. System 218 may also include a reserve 216 housed on the non-transitory MRM 208.

Instructions 220, when executed by a processor such as the processor 206, can include instructions to receive a request to mark a particular data type critical. For instance, a request may be received to mark a particular calibration setting, usage count setting, and/or customization setting as critical. The particular data type can be marked as critical, and instructions 222, when executed by a processor such as the processor 206, can include instructions to store the marked data in a reserve 216 within the non-transitory MRM 208 responsive to the request.

Instructions 224, when executed by a processor such as the processor 206, can include instructions to preserve the marked data in the reserve 216 when it is not being read by the processor 206. For instance, when the non-transitory MRM is performing a restore following replacement of the controller 204 and finds a DSID that is in the non-transitory MRM but not in a register of the firmware associated with the controller 204, the data associated with the DSID is considered an orphan and placed in the reserve 216 (e.g., the “orphanage”). The reserve 216 can preserve and update the orphan data in case firmware updates may later use it. The reserve 216 can be its own (or can create its own) CDB table on the non-transitory MRM 208. In some examples, the reserve 216 is dynamic such that it adapts to and uses whatever free space is available on the non-transitory MRM. For example, storage space of the reserve adjusts dynamically based on storage space available within the non-transitory MRM.

Instructions 226, when executed by a processor such as the processor 206, can include instructions to retrieve the marked data from the reserve using the DSID responsive to replacement of the first controller (e.g., the controller 204) with a second controller and a subsequent firmware update. In some examples, the second controller is unaware of the marked data prior to the subsequent firmware update (e.g., DSID is unknown). The marked data can be retrieved subsequent to a match between the marked data and the firmware update. For instance, the firmware update can refresh the reserve 216 to find new homes for orphaned data, including the marked data. The firmware update can include a firmware upgrade (e.g., the second controller is newer than the first controller) or a firmware downgrade (e.g., the second controller is older or is the same controller-type with fewer updates than the first controller). The marked data can be restored to the second controller upon retrieval.

In some examples, additional data such as other orphan data can be stored in the reserve 216, and that additional data can be retrieved from the reserve 216 responsive to the firmware update including a match to the additional data (e.g., refresh the reserve 216). If there is no match, the additional data can be moved to a different reserve within the non-transitory MRM 208. The different reserve can replace the reserve 216. For instance, a match for each piece of orphan data in the reserve 216 can be attempted. Upon completion of the attempts, a new reserve is created with what storage space is left in the non-transitory MRM 208, resulting in the different reserve. If any unmatched orphans remain, they are stored in the different reserve, preserved, and updated as with the reserve 216. Put another way, upon refresh of the reserve 216, the firmware update can remove the reserve 216 and create a new one of remaining orphans after attempts are made to find matches for all orphans in the reserve 216.

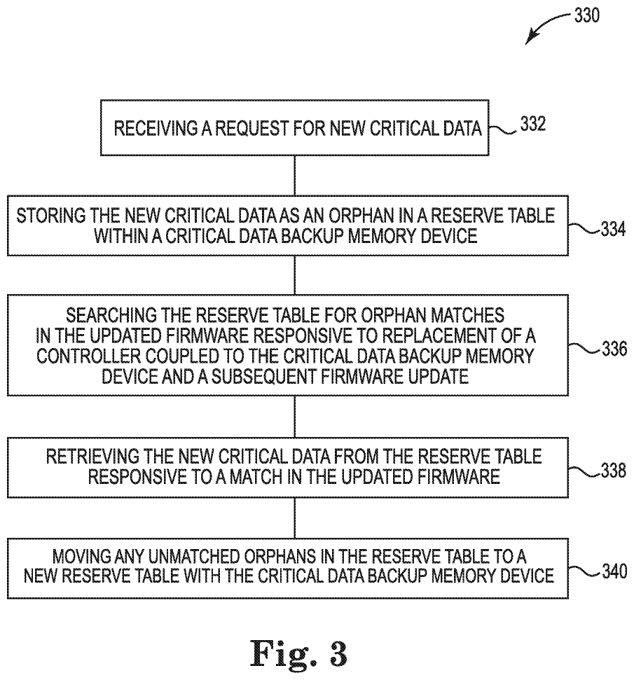

FIG. 3 is an example method 330 for critical data storage consistent with the present disclosure. For instance, the method 330 can include a method of adopting orphaned data (e.g., orphaned objects) that have been disowned by a CDB during controller replacement because of firmware changes and differences.

At 332, the method 330 includes receiving a request for new critical data. For example, data may be deemed critical subsequent to installation of a controller on a computing device. In such an example, firmware associated with the controller may be upgraded to the mark the data deemed critical as such, and the computing device can function as desired with the new critical data.

At 334, the method 330 includes storing the new critical data as an orphan in a reserve table within a CDB memory device. In some examples, the new critical data can be preserved and updated in the reserve until a firmware update matches the new critical data. The reserve table can be created within available storage space of the CDB memory device. In some examples, the reserve table includes a CDB table at the end of the CDB memory device. The reserve table can be dynamic such that it adapts and uses whatever storage space is available. In other examples, the reserve table is a block of memory at the end of the CDB memory device that lowers the size that the CDB memory device can use. In yet other examples, the reserve table can be created at the end of an orphan search and added to the CDB memory device quasi-dynamically. In some examples, a reserve table is created for each orphan and added to the CDB memory device dynamically.

The method 330, at 336, includes searching the reserve table for orphan matches in the updated firmware responsive to replacement of a controller coupled to the CDB memory device and a subsequent firmware update. For instance, when the controller is replaced with a different controller, the firmware associated with the replacement controller may be unknown. Similarly, the new critical data may be unknown to the replacement controller. Upon replacement of the controller, the firmware may be updated (e.g., via prompt to the user or automatically), and the reserve table can be searched for matches.

At 338, the method 330 includes retrieving the new critical data from the reserve table responsive to a match in the updated firmware. During the search, for instance, the new critical data, which is orphan data in the reserve table, is matched and retrieved. As a result, the new critical data is no longer unknown to the replacement controller, and the computing device can function as desired.

The method 330, at 340, includes moving any unmatched orphans in the reserve table to a new reserve table with the CDB memory device. For example, the reserve table may store a plurality of orphan data. During the firmware update, not all orphans may be matched. Whatever unmatched orphans are left create a new reserve table as a replacement for the reserve table. The storage space available for the new reserve table may be different, as may the amount of orphan data and/or number of orphans in the new reserve table as compared to the previous reserve table.

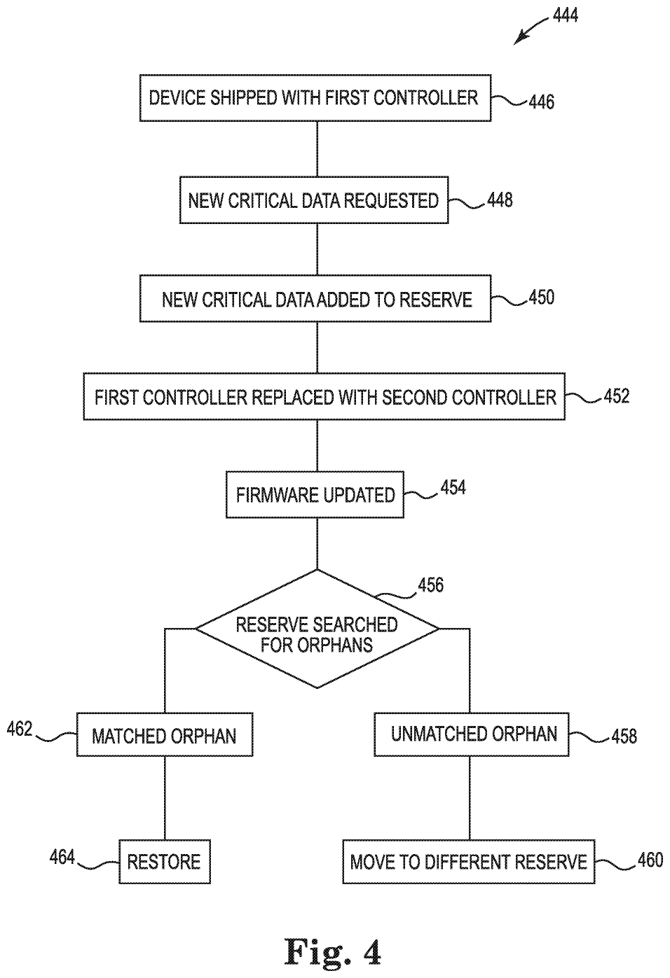

FIG. 4 is another example method 444 for critical data storage consistent with the present disclosure. The example method 444, for instance, can include an example use case, For example, at 446, the method 444 can include a computing device shipped to a user with a first controller. The computing device can include, for instance, a printing device with an MPCA. At 448, the method 444 can include receiving a new critical data request. For example, the user may determine subsequent to receipt of the printing device that a particular usage count (and it's running count) is critical data. The printing device can be reconfigured to classify the particular usage count as critical data.

At 450, the new critical data can be added to a reserve within a non-transitory MRM (e.g., CDB) of the computing device. For instance, in the aforementioned example, the particular usage count is added to a reserve within a non-transitory MRM (e.g., CDB) of the printing device. While in use, the particular usage count and its running count is stored in the non-transitory MRM and the reserve. For instance, if the new critical data is to count the number of times users print a particular logo, the desire to count such data and the running total of the data is stored, preserved, and updated in the reserve.

At 452, the first controller is replaced with a second controller. For example, a first MPCA of a printing device can be replaced with a second MPCA. The second controller may be unaware of the new critical data. For example, controllers may be mass-manufactured, and the controllers may sit in storage for a period of time, so they are available for replacement when requested. In such an example, a second controller replacing a first controller is unaware of the new critical data because the new critical data was added after manufacture of the second controller. For instance, a second MPCA that has replaced a first MPCA in a printing device may be unaware of a particular usage count. In such an example, the second MPCA may recognize that certain data is stored in the reserve (e.g., the particular usage count), but it does not know what to do with such data because the MPCA's firmware does know recognize the new critical data.

At 454, firmware of the computing device is updated. In some examples, replacement of the first controller with the second controller prompts the user to update firmware. The update can be automatic, in some examples, such that the update occurs upon replacement without user intervention. The firmware update may be an upgrade or a downgrade. At 456, the firmware updated prompts a search of the reserve for orphans. The new critical data is an orphan that may be “adopted” during the search.

If an orphan is matched during the reserve search at 462, the matched orphan is restored at 464. Zero, a portion, or all of the orphans in the reserve may be matched and restored. Because the orphan was stored, preserved, and updated in the reserve, the computing device picks up performance where it left off. For instance, the example printing device does not lose the running usage count because while in the reserve, the count continued.

If an orphan is unmatched during the reserve search at 458, the unmatched orphan is moved, at 460, to a different reserve on the non-transitory MRM. Zero, a portion, or all of the orphans in the reserve may be unmatched and moved to the different reserve. The number of unmatched orphans, as well as the remaining storage space in the non-transitory MRM determine the size of the different reserve. Like the previous reserve, the different reserve is dynamic such that it adapts and uses what storage space is available in the non-transitory MRM. In some examples, if the different reserve is over the size of the storage space available in the non-transitory MRM, the oldest orphan data (e.g., determined using DSIDs) is lost, as they may be obsoleted in future firmware updates.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A system, comprising:
a first controller comprising a processor; and
a non-transitory machine-readable medium (MRM) communicatively coupled to the processor, the non-transitory MRM containing instructions executable by the processor to cause the processor to:
receive a request for a new critical data type;
store the new critical data type in a reserve within the non-transitory MRM; and
restore the new critical data type from the reserve to a second controller responsive to replacement of the first controller with the second controller and a subsequent firmware update.

2. The system of claim 1, wherein the second controller is unaware of the new critical data.

3. The system of claim 1, further comprising the instructions executable to update the new critical data while stored in the reserve.

4. The system of claim 1, wherein the critical data type is at least one of a usage count setting, a calibration setting, and a customization setting.

5. The system of claim 1, wherein in the firmware update comprises:
a firmware downgrade responsive to the second controller having firmware associated therewith that is older than firmware associated with the first controller; and
a firmware upgrade responsive to the second controller having firmware associated therewith that is newer than firmware associated with the first controller.

6. The system of claim 1, wherein the non-transitory MRM is a critical data backup memory device.

7. A system, comprising:
a first controller comprising a processor;
a non-transitory machine-readable medium communicatively coupled to the processor, the non-transitory MRM containing instructions executable by the processor to cause the processor to:
receive a request to mark a particular data type critical;
responsive to the request, store the marked data in a reserve within the non-transitory MRM;
preserve the marked data in the reserve when it is not being read by the processor; and
retrieve the marked data from the reserve using a data store identifier responsive to replacement of the first controller with a second controller and a subsequent firmware update,
wherein the second controller is unaware of the marked data prior to the subsequent firmware update.

8. The system of claim 7, further comprising the instructions executable to retrieve the marked data subsequent to a match between the marked data and the firmware update.

9. The system of claim 7, further comprising the instructions executable to:
store additional data in the reserve;
retrieve the additional data from the reserve responsive to the firmware update including a match for the additional data; and
move the additional data to a different reserve within the non-transitory MRM responsive to the firmware update including no match for the additional data,
wherein the different reserve replaces the reserve within the non-transitory MRM.

10. The system of claim 7, wherein storage space of the reserve adjusts dynamically based on storage space available within the non-transitory MRM.

11. The system of claim 7, wherein the different reserve is created based on available storage space in the non-transitory MRM subsequent to retrieval of the marked data from the reserve.

12. The system of claim 7, further comprising the instructions executable to restore the marked data from the reserve to the second controller responsive to the retrieval of the marked data

13. A method, comprising:
receiving a request for new critical data;
storing the new critical data as an orphan in a reserve table within a critical data backup memory device;
responsive to replacement of a controller coupled to the critical data backup memory device and a subsequent firmware update, searching the reserve table for orphan matches in the updated firmware;
retrieving the new critical data from the reserve table responsive to a match in the updated firmware; and
moving any unmatched orphans in the reserve table to a new reserve table with the critical data backup memory device,
wherein the new reserve table is a replacement for the reserve table.

14. The method of claim 13, further comprising creating the reserve table within available storage space of the critical data backup memory device.

15. The method of claim 13, further comprising preserving and updating the new critical data while stored in the reserve table.
